(19) United States
(12) Patent Application Publication
(10) Pub. No.: US 2018/0103610 A1
(43) Pub. Date: Apr. 19, 2018

(54) RECEPTABLE FOR PETWATER, TREATMENT AND METHODS THEREOF

(71) Applicant: THIRSTYPET LLC, Tucson, AZ (US)

(72) Inventor: Christopher NERO, Tucson, AZ (US)

(21) Appl. No.: 15/820,618

(22) Filed: Nov. 22, 2017

Related U.S. Application Data
(63) Continuation of application No. PCT/US2017/035581, filed on Jun. 2, 2017.
(60) Provisional application No. 62/369,640, filed on Aug. 1, 2016.

(51) Int. Cl. A01K 7/00

(52) U.S. Cl. CPC A01K 7/00; A01K 5/0121

(57) ABSTRACT

Portable drinking device for pets. Portable drinking device for pets which is suitable for use when travelling with pets or when transporting pets to and from various locations, which is self-contained and pre-packaged for ease of use.

### FIELD OF THE INVENTION

The present invention relates to a portable drinking device for pets. Particularly, the present invention relates to a portable drinking device for pets which is suitable for use when travelling with pets or when transporting pets to and from various locations.

### BACKGROUND OF THE INVENTION

Pet dehydration is a major problem in the United States and worldwide. Providing drinking water to pets is critical to pet safety when travelling and when transporting pets, especially in hot environments. In hot environments, such as the southwestern United States, it is necessary to continuously supply pets with drinking water or risk pet dehydration, which is dangerous to pet health and can be fatal if a pet becomes seriously dehydrated and/or is not able to cool its body.

Dogs, for example, do not sweat through their skin and the only way for dogs to cool themselves is by panting or by drinking water. Thus, dogs are at a high risk for dehydration in hot environments. When travelling with pets, pet owners often forget to bring water for their pets and/or do not have a container to provide their pets with drinking water. Furthermore, when pets are shipped in airplanes or are transported via trains, often pets do not have sufficient drinking water for the duration of the trip.

Existing systems for providing water and food to pets include U.S. Pat. No. 367,456 to Speicher; U.S. Pat. No. 431,472 to Liggett; U.S. Pat. No. 2,874,678 to Bradley; U.S. Pat. No. 3,076,435 to Seymour; U.S. Pat. No. 4,450,790 to Stansbury, Jr.; U.S. Pat. No. 4,721,063 to Atchley; U.S. Pat. No. 4,947,796 to Robinette; U.S. Pat. No. 5,284,173 to Graves et al.; U.S. Pat. No. 5,312,019 to Tsao; U.S. Pat. No. 5,467,735 to Chrisco; U.S. Pat. No. 5,738,039 to Berman et al.; U.S. Pat. No. 5,636,592 to Wechsler; U.S. Pat. No. 5,791,287 to Gruber; U.S. Pat. No. 5,809,934 to Gavet; U.S. Pat. No. 5,809,935 to Kolterman et al.; U.S. Pat. No. 5,850,805 to Kleinasser; U.S. Pat. No. 5,960,742 to O'Rourke et al.; U.S. Pat. No. 6,101,974 to Frohlich; U.S. Pat. No. 6,257,288 to Davidian et al.; U.S. Pat. No. 6,718,911 to Greenberg; U.S. Pat. No. 6,874,445 to Polimei, Jr.; U.S. Pat. No. 6,971,331 to Rohrer; U.S. Pat. No. 7,040,249 to Mushen; U.S. Pat. No. 7,077,074 to Polimei, Jr.; U.S. Pat. No. 7,082,971 to Gauthier; U.S. Pat. No. 7,198,005 to Polimei, Jr.; U.S. Pat. No. 7,287,487 to Hurwitz; U.S. Pat. No. 7,490,577 to Stephanos; U.S. Pat. No. 7,549,392 to Wechsler; U.S. Pat. No. 7,578,261 to Fick; U.S. Pat. No. 7,690,329 to Parks; U.S. Pat. No. 7,913,647 to Martin; U.S. Pat. No. 8,011,324 to Warganich; U.S. Pat. No. 8,272,351 to Hurwitz; U.S. Pat. No. 8,601,980 to Wacker; U.S. Pat. No. 8,807,083 to Ross; U.S. Pat. No. 9,155,285 to Li; US20060236948 to Wechsler; US20070079762 to Stephanos; US20080115732 to Steinberg; US20100050950 to Graves et al.

However, none of these prior art references solve the problem of providing a portable drinking device which solves the problem when pet owners forget to bring either water for their pets or to bring a container to provide pets with drinking water. This is problematic when the pet owners are travelling with their pets, especially in hot environments such as the southwestern United States.

Accordingly, it is desirable to provide a portable drinking device and method to assure that pets are provided with drinking water in an economical and efficient manner so that pet health and safety is improved.

### SUMMARY OF THE INVENTION

To improve upon the prior art, it is an object of the invention to provide an improved portable drinking device for pets.

It is an object of the invention to provide a self-contained portable drinking device that is easily transportable and offers drinking water for pets in a pre-packaged manner, such that a pet owner is able to bring the drinking water or a liquid in a container suitable for pets drinking from the container and suitable for a pet owner to carry and transport the drinking water.

Objects of the presently claimed invention are directed solving issues related to pet dehydration. Other objects of the presently claimed invention are directed to providing a container for drinking water which is recyclable and which does not easily tip over. Other objects of the presently claimed invention are to provide a container for drinking water for pets, which is insulated and which pet owners can use to transport drinking water for pets for long periods of time and across long distances.

Other objects of the presently claimed invention are directed to providing a container for drinking water which has been treated and which is able to be stored for significant periods of time without the water quality inside the container deteriorating.

Other objects of the presently claimed invention are directed to providing a self-contained container for drinking water that is pretreated with an anti-bacterial formula and which can be stored overtime without bacterial growth in the water stored in the container.

Other objects of the presently claimed invention are directed to providing a container with low concentrations of ions and in particular low concentrations of calcium and magnesium (“soft water”).

Other objects of the presently claimed invention are directed to providing a container with water that has undergone a filtration, such that sediments and odor have been removed from the water.

Other objects of the presently claimed invention are to provide a container with nutrients and vitamins within the container.

Other objects of the presently claimed invention are to provide a container with a liquid and with flavoring, such as flavoriods.

Other objects of the presently claimed invention are to provide a container that is a carrier for vitamins and other medicinal purposes, such that the pet owners are able to provide nutrients and/or medicine to their pets in the water stored within the container.

These and other objects of the invention are achieved by a portable drinking device for pets comprising: a semi-rigid wall structure, the semi-rigid wall structure comprising a bottom and at least one sidewall having an upper rim, the bottom and the at least one sidewall forming a reservoir for holding a liquid, the reservoir having an opening at the top of the reservoir; and a removable closure element which closes the opening at the top of the semi-rigid wall structure in a water-tight way, the removable closure element being releasably attached to the upper rim of the at least one sidewall; wherein the at least one sidewall has a plurality of recess elements arranged to prevent the semi-rigid wall structure from tipping over when a pet is drinking the liquid from the reservoir; and wherein the removable closure element seals the liquid within the reservoir during transport of the portable drinking device, wherein the portable drinking device is pre-packed with liquid.

In certain embodiments, the plurality of recess elements include just a single recess element or no recess element at all. In certain embodiments, the container is devoid of or does not include recess elements on the at least one sidewall.

In certain embodiments, the semi-rigid wall structure is circular.

In certain embodiments, the semi-rigid wall structure is selected from a group consisting of a square, triangle, polygon, hexagon, and another shape that is suitable for a pet.

In certain embodiments, the semi-rigid wall structure is made of plastic or a recyclable material. In certain embodiments, the semi-rigid wall structure is able to break down and decompose, so it is not to be hazardous for the environment.

It certain embodiments, the semi-rigid wall structure can decompose over time. In certain embodiments, the semi-rigid wall structure is made of a material that can be broken down and decomposed by bacteria found in the environment.

In certain embodiments, the plurality of recess elements in the semi-rigid wall structure repeat themselves in a pattern around the at least one sidewall.

In certain embodiments, each of the plurality of recess elements are triangular and extend outwardly from the center of the reservoir.

In certain embodiments, each of the plurality of recess elements are tear-shaped or pear shaped and extend outwardly from the center of the reservoir.

In certain embodiments, the plurality of recess elements taper from the top to the bottom, such that the plurality of recess elements have a wider cross-section at a portion of the plurality of recess elements that are closer to the bottom of the portable drinking device.

In certain embodiments, the upper rim of the at least one sidewall is oriented perpendicular to the at least one sidewall, and extending away from the at least one sidewall.

In certain embodiments, the upper rim includes an adhesive to secure the removable closure element to the upper rim.

In certain embodiments, the upper rim extends beyond the base of the device.

In certain embodiments, the removable closure element can be resealable.

In certain embodiments, the bottom of the semi-rigid wall structure has a logo indentation.

In certain embodiments, the logo indentation prevents the semi-rigid wall structure from tipping over when a pet is drinking the liquid from the reservoir. In certain embodiments, the logo indentation provides traction, so that the device is able to create static friction against the ground to prevent the device from tipping over.

In certain embodiments, the bottom surface of the container includes traction and is made of a different material than the at least one sidewall.

In certain embodiments, the bottom surface of the container is weighted and/or is heavier than the at least one sidewall.

In certain embodiments, the removable closure element is insulated. In certain embodiments, the removable closure element is made of a paper or opaque material that insulates against sunlight, heat and evaporation of liquid.

In certain embodiments, the removable closure device further comprises a conductive element that transfers heat.

In certain embodiments, the removable closure element is made of a metallic material.

In certain embodiments, the portable drinking device includes water that has been pre-treated. In certain embodiments, the portable drinking device includes water that can be stored for significant periods of time without the water quality inside the container deteriorating.

In certain embodiments, the pre-treated water has been cleaned of bacteria and/or is taken from a pure water source.

In certain embodiments, the water is pretreated with an anti-bacterial formula and which can be stored overtime without bacterial growth in the water stored in the container.

In certain embodiments, the water is soft water, i.e. includes low concentrations of ions and in particular low concentrations of calcium and magnesium.

In certain embodiments, the water in the portable container has undergone a filtration, such that sediments and odor have been removed from the water.

In certain embodiments, the water in the portable container contains nutrients and vitamins.

In certain embodiments, the water in the portable container contains a flaveroid.

In certain embodiments, the removable closure element is a lid.

In certain embodiments, the removable closure element is a lid of various sizes and various shapes.

In certain embodiments, the lid is removable.

In certain embodiments, the lid contains multiple layers and insulation layers.

Other objects of the invention are achieved by providing a portable drinking device for pets comprising: a circular water bowl holding a liquid; and a removable closure element which closes an opening at the top of the circular water bowl in a water-tight way, wherein the circular water bowl has a plurality of recess elements arranged to prevent the circular water bowl from tipping over when a pet is drinking the liquid from the circular water bowl; and wherein the removable closure element seals the liquid within the circular water bowl during transport of the portable drinking device.

In certain embodiments, the circular water bowl has a logo indentation at the bottom of the circular water bowl, the logo indentation preventing the circular water bowl from tipping over when a pet is drinking the liquid from the circular water bowl.

In certain embodiments, the portable drinking device further comprises printed material on the removable closure element providing instructions for use of the portable drinking device.

In certain embodiments, the instructions for use of the portable drinking device include key information about pet safety and hydration that are geared towards different pets.

In certain embodiments, the circular water bowl is pre-packed with liquid.

In certain embodiments, the circular water bowl is sold to consumers in ready to go form whereby the consumer simply has to remove the removable closure element, so that pets have access to the drinking water.

In certain embodiments, the portable drinking device and instructions are sold together as a kit.

Other objects of the invention are achieved by providing a method for providing drinking water to a pet, the method comprising: providing a circular water bowl holding a liquid, the circular water bowl having a removable closure element which closes an opening at the top of the circular water bowl in a water-tight way to prevent the liquid from exiting the circular water bowl during transport of the circular water bowl; removing the removable closure element from the circular water bowl; and allowing the pet to access to the circular water bowl to drink the liquid in the circular water bowl, wherein the circular water bowl is pre-packaged with the liquid.

In certain embodiments, the step of providing the circular water bowl to the pet occurs when the pet is outside of the home of a pet or when the pet is being transported or walked.

In certain embodiments, the method occurs during hot conditions when the temperature is greater than 80 degrees Fahrenheit.

In certain embodiments, the method occurs during hot conditions when the temperature is greater than 60 degrees Fahrenheit.

In certain embodiments, the method occurs during dry hot conditions or humid conditions where pets naturally lose a lot of water.

In certain embodiments, the method further comprises transporting the circular water bowl from a first location to a second location prior to the step of allowing the access to the circular water bowl to drink the liquid.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1A is a portable drinking device of an embodiment of the application;

FIG. 1B is a series of portable drinking devices without removable closure elements of FIG. 1A;

FIG. 1C is a series of portable drinking devices of FIG. 1A without removable closure elements and filled partially with water;

FIG. 2A is a perspective view of a portable drinking device of an embodiment of the application showing the water within the container;

FIG. 2B is a bottom view of the portable drinking device of FIG. 2A showing a logo at the bottom of the device;

FIGS. 3A-E are front views of indicia on the removable closure element of various portable drinking devices showing different size containers;

FIGS. 4-5 are perspective views of various portable drinking devices of different sizes;

FIG. 6 is a perspective view of a mold used to create the portable drinking devices;

FIGS. 7-8 are view of various molds used to create the portable drinking devices; and

FIG. 9 is a side view of an embodiment of the present invention showing a resealable cover for the container.

### DETAILED DESCRIPTION OF THE INVENTION

In the following description, numerous details are set forth for purpose of explanation. However, one of ordinary skill in the art will realize that the invention may be practiced without the use of these specific details. For instance, the techniques described below are described in a specified order, but other embodiments may change the order of the operations while still embodying the current invention.

The invention is very valuable pet owners to prevent their pets from being dehydrated. Objects of the presently claimed invention are directed solving issues related to pet dehydration and to provide a device which is easily transportable, self-contained and provides drinking water to pets. Other objects of the presently claimed invention are directed to providing a container for drinking water which is recyclable and which does not easily tip over. Other objects of the presently claimed invention are to provide a container for drinking water for pets, which is insulated and which pet owners can use to transport drinking water for pets for long periods of time and across long distances.

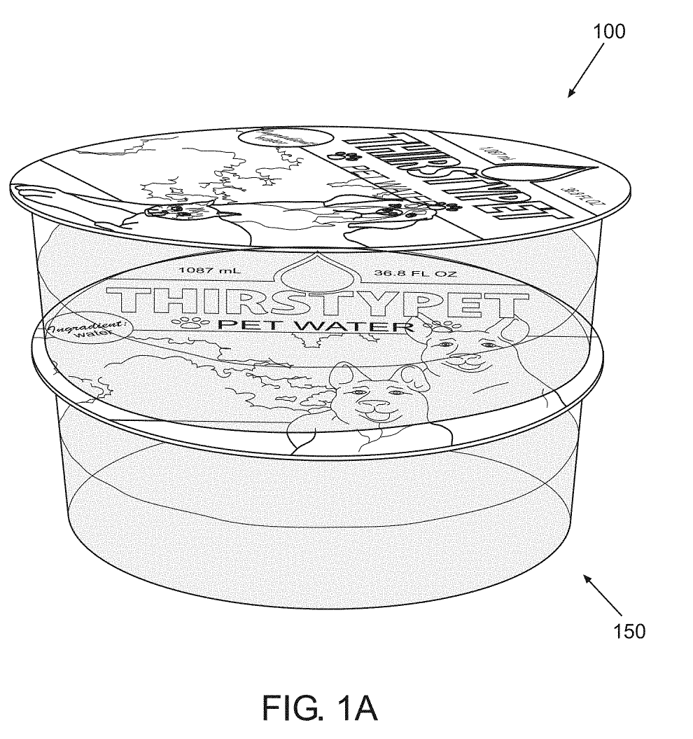

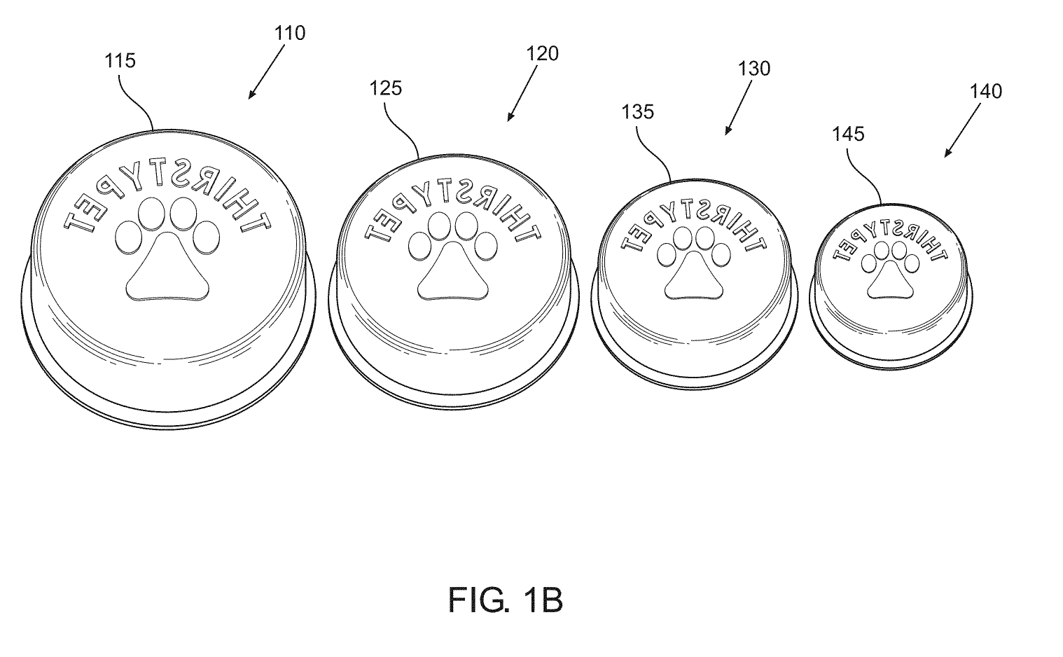

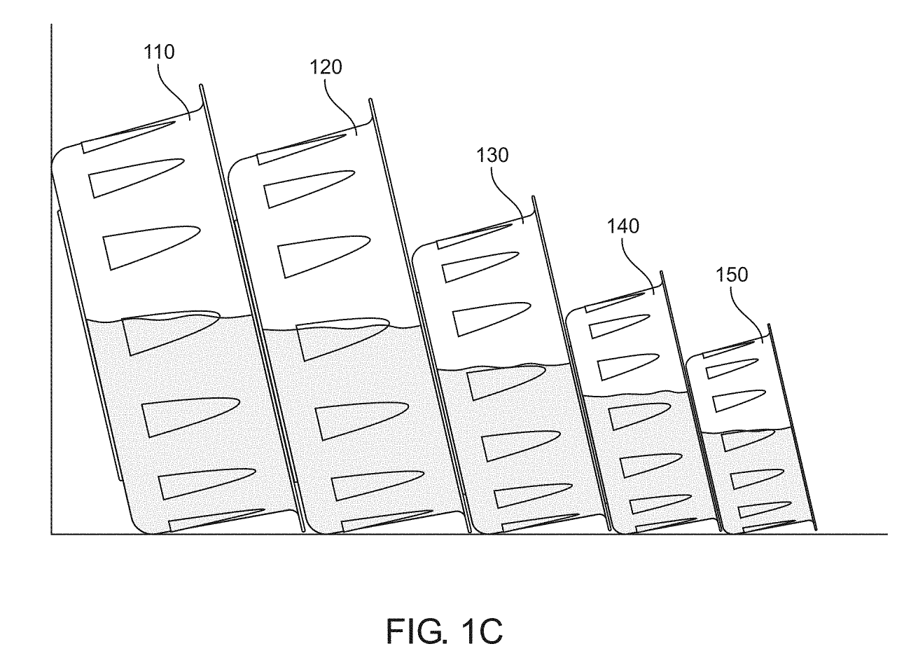

Referring to FIG. 1A, two examples 100, 150 of the portable drinking devices of an embodiment of the invention are shown. FIG. 1 shows the semi-rigid wall structure and bottom of the device as well the removable closure element sealing the opening at the top of the semi-rigid wall structure.

In certain embodiments, the removable closure element has indicia on the removable closure element. In certain embodiments, the removable closure element is made from paper and/or aluminum foil. In certain embodiments, the removable closure element is insulative and/or conductive of heat. In certain embodiments, the removable closure element is connected to a rim on the semi-rigid wall structure via an adhesive. In certain embodiments, the removable closure includes a plastic skin and/or may have a thin plastic lid.

Referring to FIG. 1B, the semi-rigid wall structure and bottom of various devices (110, 120, 130 and 140) are shown, which are each of various sizes. The smallest device 140 is a 3-inch device, the next device 130 is a 4-inch device, the next device 120 is a 5-inch device and the largest device 110 is 6.5 inches in diameter. Each of the devices are geared towards pets of different sizes and weights whereby the largest diameter devices are for the largest pets.

In certain embodiments, devices having larger or smaller diameters are able to be provided depending upon the size of the pet.

Veterinarians recommend 0.5-1.5 ounces of water per day per pound of body weight for dogs or cats and the devices are designed to provide water to pets of various sizes.

Also in FIG. 1B, the indicia (115, 125, 135 and 145) is shown on the bottom of the devices (110, 120, 130 and 140). The indicia is pressed into bottom of the device and is contiguous with the bottom the device. As shown the logo of a paw print and THIRSTYPET is shown at the bottom of the device. The orientation of the logo and THIRSTYPET text helps balance the device to prevent the device from being tipped over when a pet is drinking from the device.

FIG. 1C shows various devices (110, 120, 130, 140, 150) of different sizes on their sides with water within the devices. The devices are pre-packaged, pre-sealed and prevent evaporation of the water from the device as well as from leaking.

The devices are to be sold to consumers in a pre-packaged form with liquid, such as water or treated water, inside the device so all a user has to do is open the device and give the drinking water to pets.

In certain embodiments, the devices may include vitamins and/or medicine to be provided to pets. In certain embodiments, the devices act as a carrier for nutrients, vitamins and/or medicine.

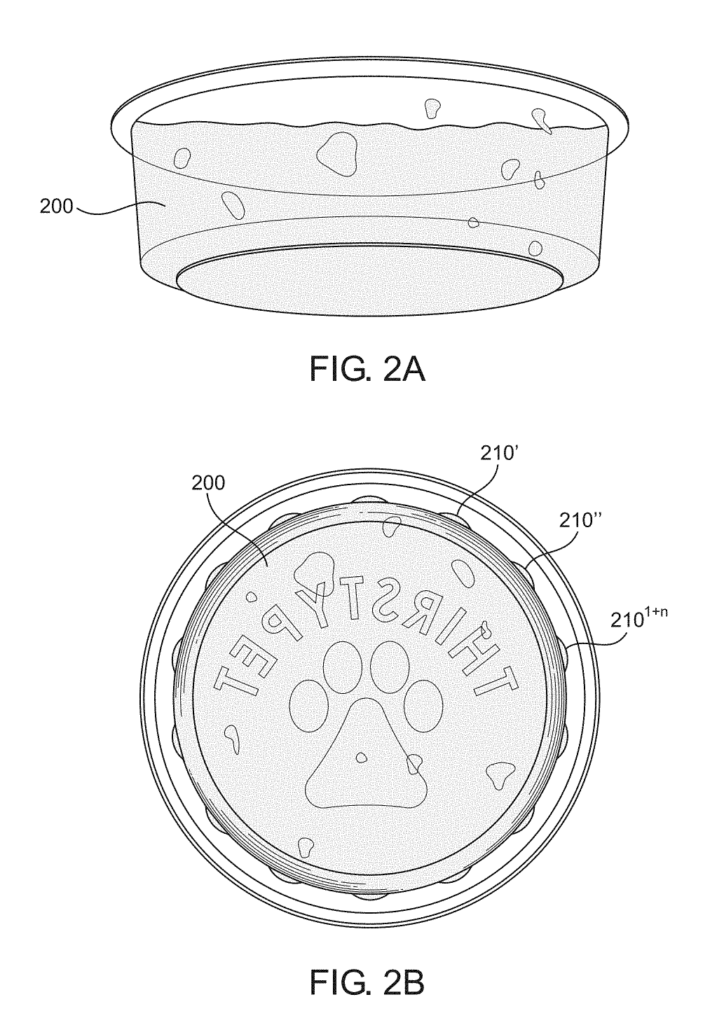

FIGS. 1C and 2B shows the plurality of recesses (210, 210′, 210″ . . . , 210′⁺ⁿ) on the sidewall of the device. The plurality of recesses can have different shapes and are used to prevent the device from being tipped over and stabilize the device. In FIGS. 1C and 2B the plurality of recesses are shown tapering from the top of the bottom of the device and that the plurality of recesses are triangular or tear shaped. However various other shapes of the plurality of recesses are contemplated. Moreover, the device, while shown as being circular, can be rectangular, oval, square, triangular and other various shapes.

Furthermore, in certain embodiments, rather than having a plurality of recesses, a plurality of external protrusions can be formed on the sidewall of the device.

FIG. 2B shows the indicia on the bottom of the device which is the paw print and the THIRSTYPET indicia which helps keep the device from tipping over as well as the plurality of recesses (210, 210′, 210″ . . . , 210′⁺ⁿ) on the sidewall of the device

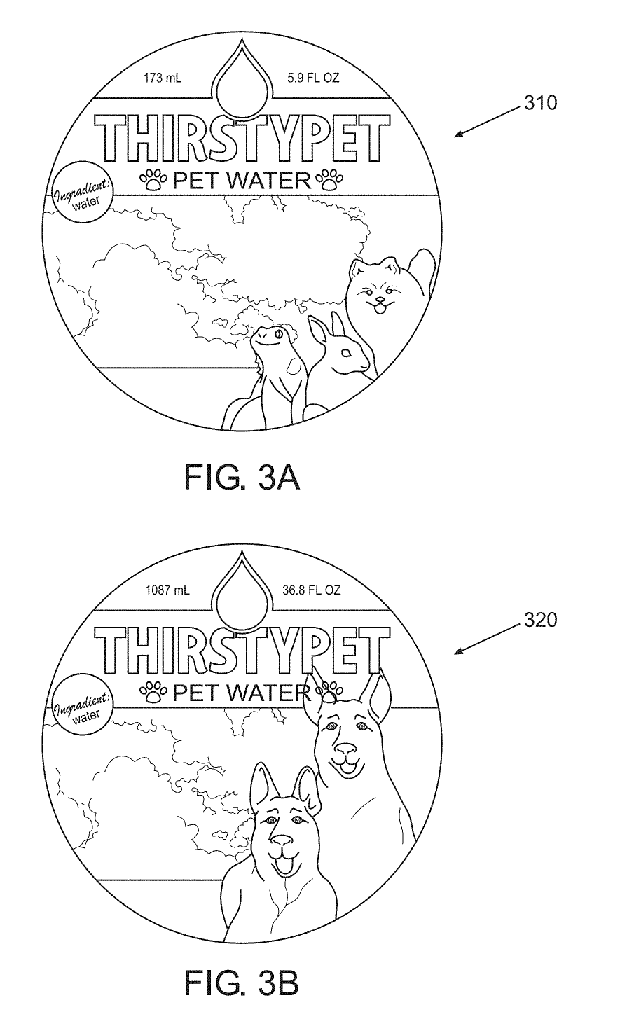

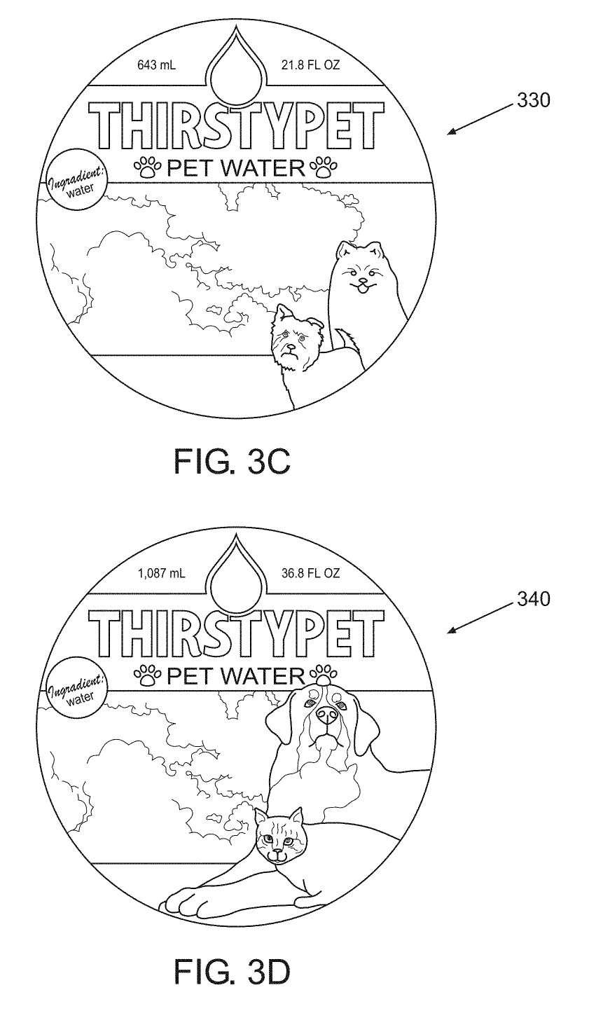

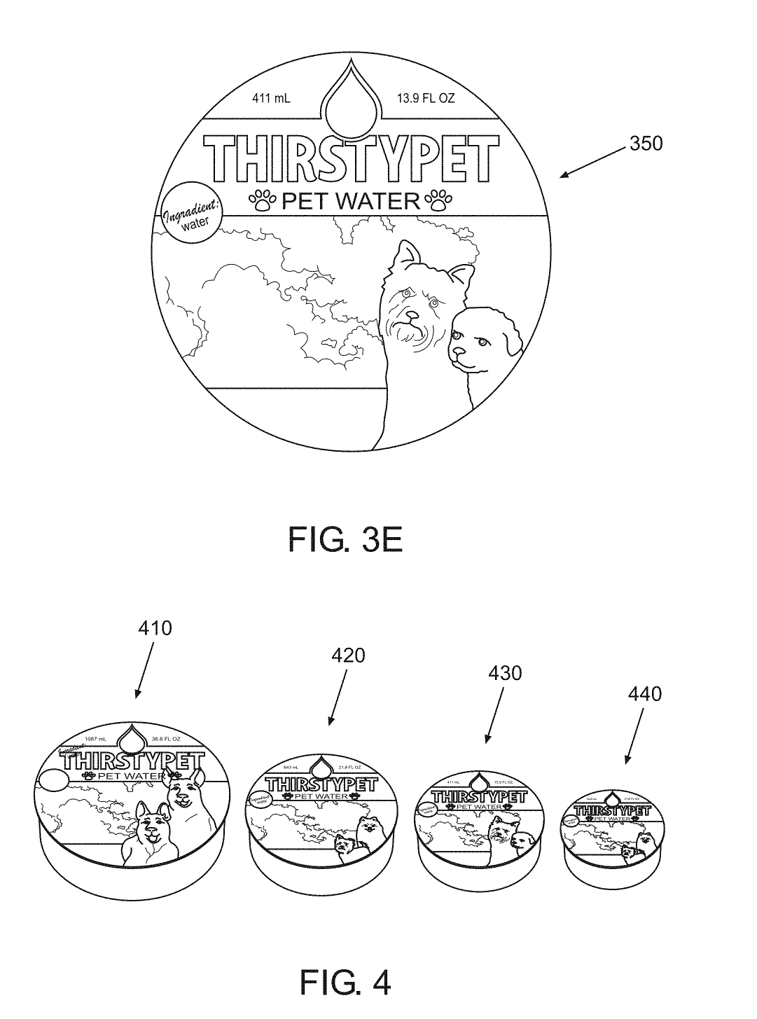

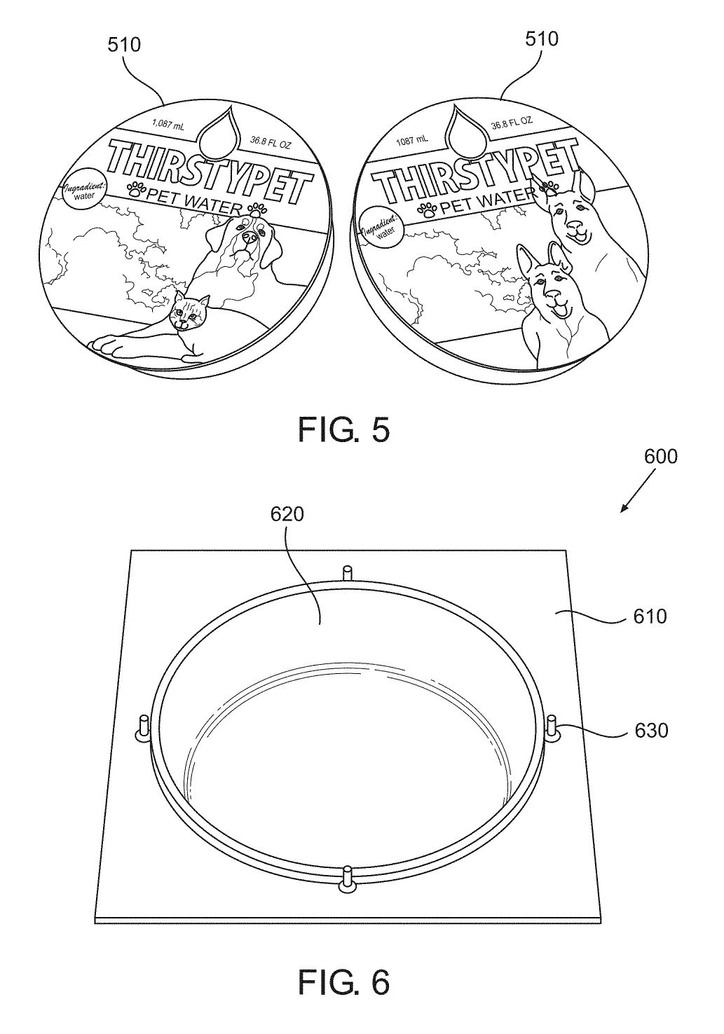

FIGS. 3A-3E show labeling and instructions of the devices (310, 320, 330, 340 and 350) which includes the volume of the device in mL and in fluid ounces, so that a pet owner will know how much water to give his or her pet during travel each day. FIGS. 4-5 show various perspective views of the devices (410, 420, 430, 440, 510 and 520) with the labeling.

FIG. 6 is a view of a mold 600 used to create the portable drinking devices. The mold includes a cast 610, portable mold part 620 and attachment mechanism 630 connecting the cast 610 to the portable mold part.

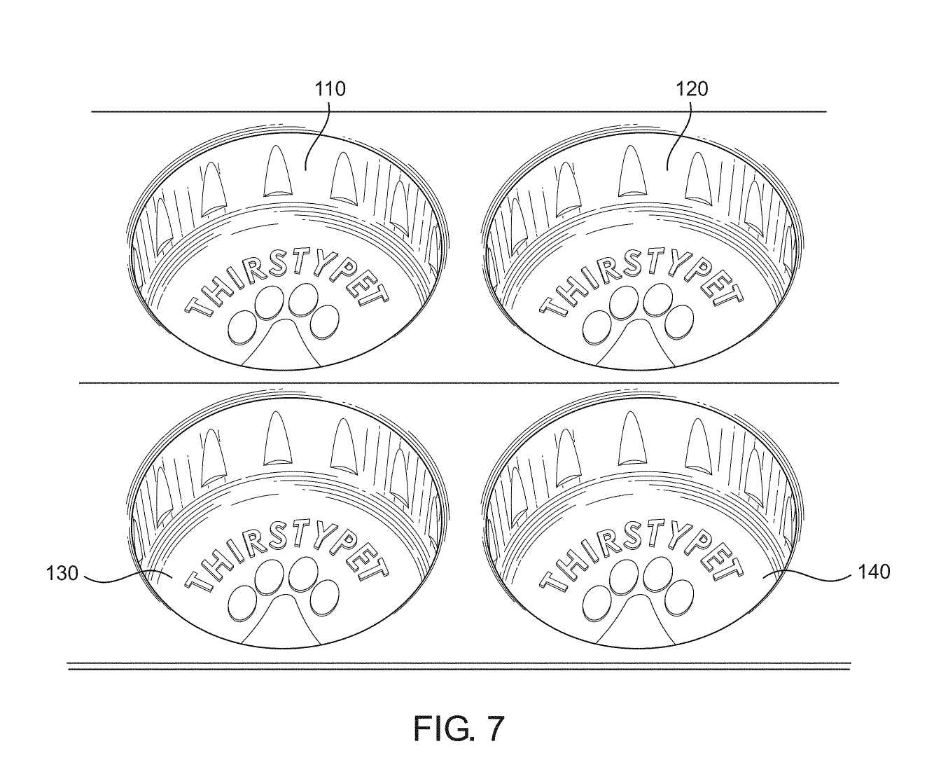

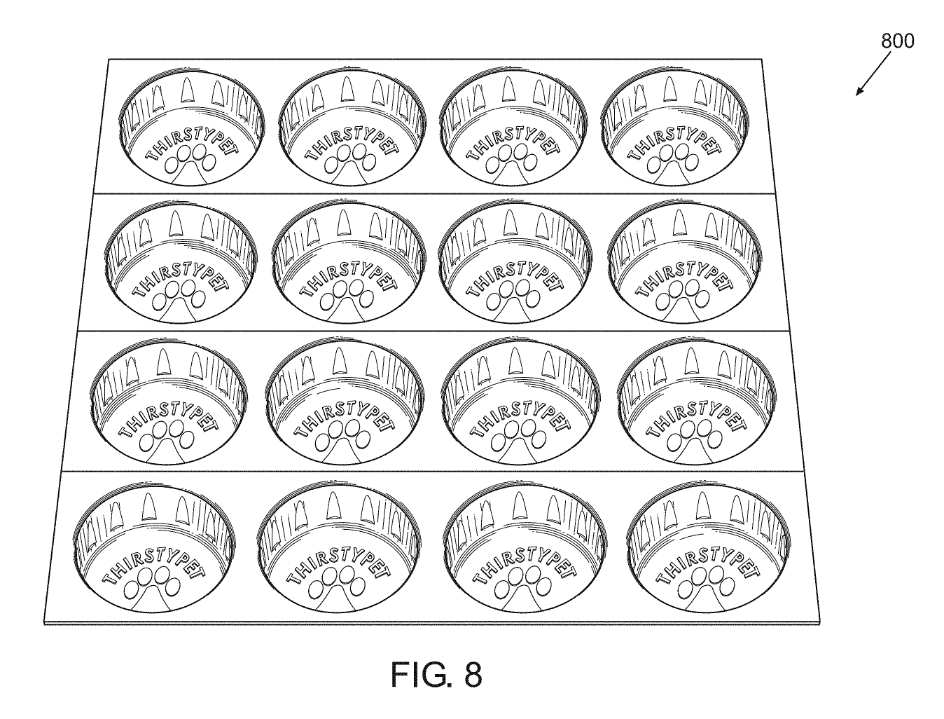

FIGS. 7-8 are views of various molds (710, 720, 730, 74) and sheet 800 used to create the portable drinking devices, so that the drinking devices can be manufactured on a large scale.

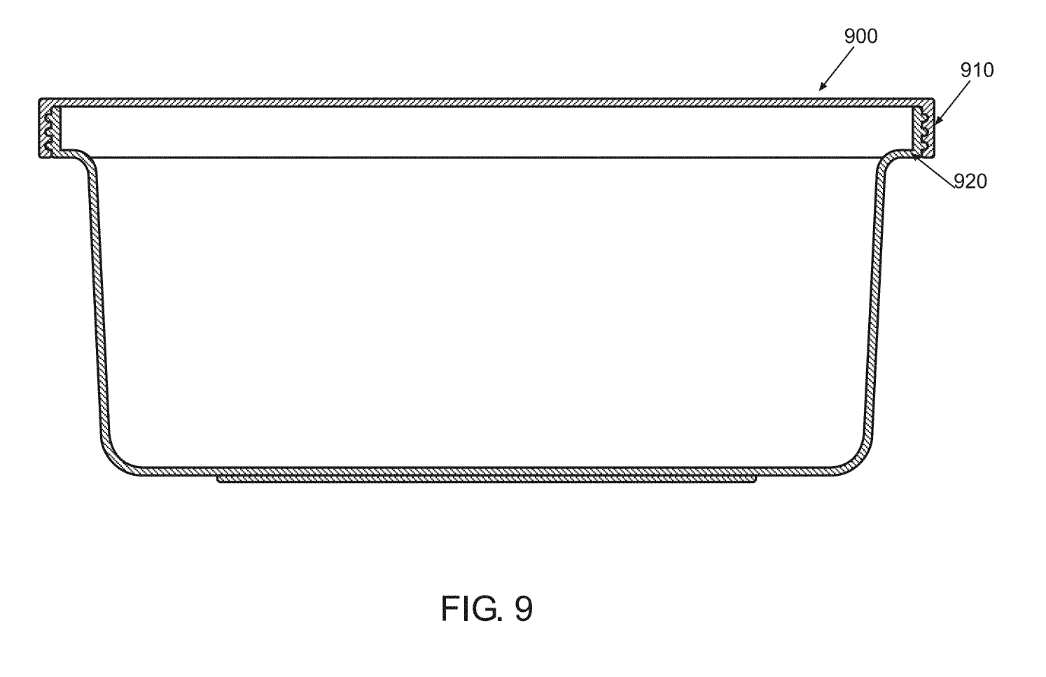

FIG. 9 is a view of another embodiment of the container 900, which has a resealable cover 910 attached to the at least one sidewall 920. In this embodiment, the cover 910 attaches to the sidewall 920 in a similar manner to a Ziplock bag connection whereby a seal is formed.

In certain embodiments, a zipper seal and a double zipper seal can be used to connect the cover the sidewall. In certain embodiments, the zipper seal is on the top rim of the sidewall or on an external outer surface of the sidewall.

In certain embodiments, the cover and sidewall connect with one another with a male-female connection such that either the sidewall or the cover have the male-female connection members.

In certain embodiments, the male-female connection include channels to provide a strong seal between the resealable cover and sidewall.

In certain embodiments, the device is made from glass and in other embodiments, the device is made from plastics and/or a combination of plastic materials.

In certain embodiments, the device is recyclable and/or biodegradable.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

1. A portable drinking device for pets comprising:
a semi-rigid wall structure, the semi-rigid wall structure comprising a bottom and at least one sidewall having an upper rim, the bottom and the at least one sidewall forming a reservoir for holding a liquid, the reservoir having an opening at the top of the reservoir; and
a removable closure element which closes the opening at the top of the semi-rigid wall structure in a water-tight way, the removable closure element being releasably attached to the upper rim of the at least one sidewall;
wherein the at least one sidewall has a plurality of recess elements arranged to prevent the semi-rigid wall structure from tipping over when a pet is drinking the liquid from the reservoir; and
wherein the removable closure element seals the liquid within the reservoir during transport of the portable drinking device,
wherein the portable drinking device is pre-packed with liquid.

2. The portable drinking device of claim 1, wherein the semi-rigid wall structure is circular.

3. The portable drinking device of claim 1, wherein the semi-rigid wall structure is made of plastic or a recyclable material.

4. The portable drinking device of claim 1, wherein the plurality of recess elements repeat themselves in a pattern around the at least one sidewall.

5. The portable drinking device of claim 1, wherein each of the plurality of recess elements are triangular and extend outwardly from the center of the reservoir.

6. The portable drinking device of claim 1, wherein each of the plurality of recess elements are tear-shaped or pear shaped and extend outwardly from the center of the reservoir.

7. The portable drinking device of claim 1, wherein the plurality of recess elements taper from the top to the bottom, such that the plurality of recess elements have a wider cross-section at a portion of the plurality of recess elements that are closer to the bottom of the portable drinking device.

8. The portable drinking device of claim 1, wherein the upper rim of the at least one sidewall is oriented perpendicular to the at least one sidewall, and extending away from the at least one sidewall.

9. The portable drinking device of claim 8, wherein the upper rim includes an adhesive to secure the removable closure element to the upper rim.

10. The portable drinking device of claim 1, wherein the bottom of the semi-rigid wall structure has a logo indentation.

11. The portable drinking device of claim 10, wherein the logo indentation prevents the semi-rigid wall structure from tipping over when a pet is drinking the liquid from the reservoir.

12. The portable drinking device of claim 1, wherein the removable closure element is insulated.

13. The portable drinking device of claim 12, wherein the removable closure device further comprises a conductive element that transfers heat.

14. A portable drinking device for pets comprising:
a circular water bowl holding a liquid; and
a removable closure element which closes an opening at the top of the circular water bowl in a water-tight way,
wherein the circular water bowl has a plurality of recess elements arranged to prevent the circular water bowl from tipping over when a pet is drinking the liquid from the circular water bowl; and
wherein the removable closure element seals the liquid within the circular water bowl during transport of the portable drinking device.

15. The portable drinking device of claim 14, wherein the circular water bowl has a logo indentation at the bottom of the circular water bowl, the logo indentation preventing the circular water bowl from tipping over when a pet is drinking the liquid from the circular water bowl.

16. The portable drinking device of claim 14, further comprising printed material on the removable closure element providing instructions for use of the portable drinking device.

17. The portable drinking device of claim 14, wherein the circular water bowl is pre-packed with liquid.

18. A method of providing drinking water to a pet, the method comprising:
providing a circular water bowl holding a liquid, the circular water bowl having a removable closure element which closes an opening at the top of the circular water bowl in a water-tight way to prevent the liquid from exiting the circular water bowl during transport of the circular water bowl;
removing the removable closure element from the circular water bowl; and
allowing the pet to access to the circular water bowl to drink the liquid in the circular water bowl,
wherein the circular water bowl is pre-packaged with the liquid.

19. The method of claim 18, wherein the step of providing the circular water bowl to the pet occurs when the pet is outside of the home of a pet or when the pet is being transported or walked.

20. The method of claim 18, wherein the method occurs during hot conditions when the temperature is greater than 80 degrees Fahrenheit.

21. The method of claim 18, further comprising transporting the circular water bowl from a first location to a second location prior to the step of allowing the access to the circular water bowl to drink the liquid.
